(19) United States
(12) Patent Application Publication
(10) Pub. No.: US 2025/0140204 A1
(43) Pub. Date: May 1, 2025

(54) DRIVING CIRCUIT

(71) Applicant: SAMSUNG DISPLAY CO., LTD., Yongin-si (KR)

(72) Inventors: Keukjin Jeong, Yongin-si (KR); Wongyun Kim, Yongin-si (KR); Min Kang, Yongin-si (KR)

(21) Appl. No.: 18/886,778

(22) Filed: Sep. 16, 2024

(30) Foreign Application Priority Data
Oct. 30, 2023 (KR) 10-2023-0147150

(51) Int. Cl. G09G 3/3266

(52) U.S. Cl. CPC G09G 3/3266; G09G 2310/0286; G09G 2310/08

(57) ABSTRACT

Provided are a driving circuit including a plurality of stages. Each stage comprises: a first transistor connected between a first terminal and a first node and configured to control a voltage level of the first node, the first terminal receiving a first signal; a second transistor connected between a second terminal and a second node and configured to control a voltage level of the second node, the second terminal receiving a second signal; a third transistor connected between a third terminal and the second node and configured to control the voltage level of the second node, the third terminal receiving a third signal; and an output circuit configured to output a corresponding gate signal of one of a high-level voltage and a low-level voltage according to the voltage level of the first node and the voltage level of the second node.

### CROSS-REFERENCE TO RELATED APPLICATION

This application is based on and claims priority under 35 U.S.C. § 119 to Korean Patent Application No. 10-2023-0147150, filed on Oct. 30, 2023, in the Korean Intellectual Property Office, the disclosure of which is incorporated by reference herein in its entirety.

### BACKGROUND

### 1. Field

The present disclosure relates to a display apparatus, and more particularly, to a driving circuit that outputs gate signals and a display apparatus including the driving circuit.

### 2. Description of the Related Art

A display apparatus includes a pixel area including a plurality of pixels, a gate driving circuit, a data driving circuit, and a controller. The gate driving circuit includes stages connected to gate lines, and the stages supply gate signals through gate lines connected thereto in response to signals from the controller.

### SUMMARY

One or more embodiments include a gate driving circuit having a small size and capable of stably outputting a gate signal and a display apparatus including the gate driving circuit. Technical objectives to be achieved by the disclosure are not limited thereto, and other unmentioned technical objectives will be apparent to one of ordinary skill in the art to which the disclosure pertains from the following description.

Additional aspects will be set forth in part in the description which follows and, in part, will be apparent from the description, or may be learned by practice of the presented embodiments.

According to an aspect of the present disclosure, a driving circuit includes a plurality of stages that output a plurality of gate signals to a plurality of pixels. The plurality of stages include a first stage, a last stage, and a plurality of intervening stages which are connected with each other in series. The plurality of intervening stages are connected with each other in series and disposed between the first stage and the last stage. Each of the plurality of stages includes a first transistor connected between a first terminal and a first node and configured to control a voltage level of the first node, wherein the first terminal receives a first signal, a second transistor connected between a second terminal and a second node and configured to control a voltage level of the second node, wherein the second terminal receives a second signal, a third transistor connected between a third terminal and the second node and configured to control the voltage level of the second node, wherein the third terminal receives a third signal, and an output circuit configured to output a corresponding gate signal, among the plurality of gate signals, of one of a high-level voltage and a low-level voltage according to the voltage level of the first node and the voltage level of the second node.

The first stage receives an external signal as the first signal, and each of the last stage and the plurality of intervening stages receives a corresponding gate signal, among the plurality of gate signals, output from a previous stage of the plurality of stages.

A gate of each of the first transistor, the second transistor, and the third transistor is connected to a first clock terminal receiving a first clock signal. The first transistor and the second transistor are P-type transistors, and the third transistor is an N-type transistor.

The second signal may be a first voltage of a low level, and the third signal may be a second voltage of a high level.

A gate of each of the first transistor, the second transistor, and the third transistor may be connected to a first clock terminal receiving a first clock signal. The first transistor and the third transistor are P-type transistors, and the second transistor is an N-type transistor.

The second signal may be a same signal as the first signal, and the third signal may be a first voltage of a low level.

A gate of each of the first transistor and the second transistor may be connected to a first clock terminal to which a first clock signal is input, a gate of the third transistor may be connected to a second clock terminal to which a second clock signal is input, the first transistor is a P-type transistor, and the second transistor and the third transistor are N-type transistors.

The second signal may be a same signal as the first signal, and the third signal may be the first clock signal.

Each of the plurality of stages may further include a fourth transistor connected between the first transistor and the first node and including a gate connected to a terminal to which a first voltage of a low level is input.

The fourth transistor may include two sub-transistors that are connected in series.

Each of the plurality of stages may further include a capacitor connected between the first node and a terminal to which a first voltage of a low level is supplied.

The output circuit may include a pull-down transistor connected between an output terminal and a clock terminal and including a gate connected to the first node, a pull-up transistor connected between a terminal to which a second voltage of a high level is supplied and the output terminal and including a gate connected to the second node, and a capacitor connected between the first node and the output terminal.

According to an aspect of the present disclosure, a driving circuit includes a plurality of stages that output a plurality of gate signals to a plurality of pixels. Each of the plurality of stages includes a first transistor connected between a first node and an input terminal to which a start signal is input and comprising a gate connected to a first clock terminal to which a first clock signal is input, a second transistor connected between a second node and a first voltage input terminal to which a first voltage of a low level is input and comprising a gate connected to the first clock terminal, a third transistor connected between the second node and a second voltage input terminal to which a second voltage of a high level is input and comprising a gate connected to the first clock terminal, and an output circuit connected to the second voltage input terminal and a second clock terminal to which a second clock signal is input and configured to output a corresponding gate signal, among the plurality of gate signals, of one of a high-level voltage and a low-level voltage according to a voltage level of the first node and a voltage level of the second node. The first transistor and the second transistor are P-type transistors, and the third transistor is an N-type transistor.

Each of the plurality of stages may further include a fourth transistor connected between the first transistor and the first node and including a gate connected to the first voltage input terminal.

The fourth transistor may include two sub-transistors that are connected in series.

Each of the plurality of stages may further include a capacitor connected between the first node and the first voltage input terminal.

According to an embodiment of the present disclosure, a driving circuit includes a plurality of stages that output a plurality of gate signals to a plurality of pixels. Each of the plurality of stages includes a first transistor connected between a first node and an input terminal to which a start signal is input and comprising a gate connected to a first clock terminal to which a first clock signal is input, a second transistor connected between the input terminal and a second node and comprising a gate connected to the first clock terminal, a third transistor connected between the first clock terminal and the second node and comprising a gate connected to a second clock terminal to which a second clock signal is input, and an output circuit connected between the second clock terminal and a first voltage input terminal to which a first voltage of a high level is input and configured to output a corresponding gate signal, among the plurality of gate signals, of one of a high-level voltage and a low-level voltage according to a voltage level of the first node and a voltage level of the second node. The first transistor is a P-type transistor, and the second transistor and the third transistor are N-type transistors.

Each of the plurality of stages may further include a fourth transistor connected between the first transistor and the first node and including a gate connected to a second voltage input terminal to which a second voltage of a low level is input.

The fourth transistor may include two sub-transistors that are connected in series.

Each of the plurality of stages may further include a capacitor connected between the first node and a second voltage input terminal to which a second voltage of a low level is input.

According to an aspect of the present disclosure, a driving circuit includes a plurality of stages that output a plurality of gate signals to a plurality of pixels. Each of the plurality of stages includes a first transistor connected between a first node and an input terminal to which a start signal is input and comprising a gate connected to a first clock terminal to which a first clock signal is input, a second transistor connected between the input terminal and a second node and comprising a gate connected to the first clock terminal, a third transistor connected between the second node and a first voltage input terminal to which a first voltage of a low level is input and comprising a gate connected to the first clock terminal, and an output circuit connected between a second voltage input terminal to which a second voltage of a high level is input and a second clock terminal to which a second clock signal is input and configured to output a corresponding gate signal, among the plurality of gate signals, of one of a high-level voltage and a low-level voltage according to a voltage level of the first node and a voltage level of the second node. The first transistor and the third transistor are P-type transistors, and the second transistor is an N-type transistor.

Each of the plurality of stages may further include a fourth transistor connected between the first transistor and the first node and including a gate connected to the first voltage input terminal.

The fourth transistor may include two sub-transistors that are connected in series.

Each of the plurality of stages may further include a capacitor connected between the first node and the first voltage input terminal.

### BRIEF DESCRIPTION OF THE DRAWINGS

The above and other aspects, features, and advantages of certain embodiments will be more apparent from the following description taken in conjunction with the accompanying drawings, in which:

FIG. 1 is a diagram illustrating a display apparatus according to an embodiment of the present disclosure;

FIG. 2 is a diagram illustrating a gate driving circuit according to an embodiment of the present disclosure;

FIG. 3 is a circuit diagram illustrating an example of a stage included in the gate driving circuit of FIG. 2 according to an embodiment of the present disclosure;

FIG. 4 is a timing diagram for describing an operation of the stage of FIG. 3 according to an embodiment of the present disclosure;

FIGS. 5 and 6 are circuit diagrams illustrating an example of a stage included in the gate driving circuit of FIG. 2 according to an embodiment of the present disclosure;

FIG. 7 is a circuit diagram illustrating an example of a stage included in the gate driving circuit of FIG. 2 according to an embodiment of the present disclosure;

FIG. 8 is a timing diagram for describing an operation of the stage of FIG. 7 according to an embodiment of the present disclosure;

FIGS. 9 and 10 are circuit diagrams illustrating an example of a stage included in the gate driving circuit of FIG. 2 according to an embodiment of the present disclosure;

FIG. 11 is a circuit diagram illustrating an example of a stage included in the gate driving circuit of FIG. 2 according to an embodiment of the present disclosure;

FIG. 12 is a timing diagram for describing an operation of the stage of FIG. 11 according to an embodiment of the present disclosure; and

FIGS. 13 and 14 are circuit diagrams illustrating an example of a stage included in the gate driving circuit of FIG. 2 according to an embodiment of the present disclosure.

### DETAILED DESCRIPTION

Reference will now be made in detail to embodiments, examples of which are illustrated in the accompanying drawings. Like reference numerals refer to like elements throughout. In this regard, the present embodiments may have different forms and should not be construed as being limited to the descriptions set forth herein. Accordingly, the embodiments are merely described below, by referring to the figures, to explain aspects of the present disclosure. As used herein, the term “and/or” includes any and all combinations of one or more of the associated listed items. Throughout the disclosure, the expression “at least one of a, b and c” indicates only a, only b, only c, both a and b, both a and c, both b and c, all of a, b, and c, or variations thereof.

As the disclosure allows for various changes and numerous embodiments, certain embodiments will be illustrated in the drawings and described in the detailed description. Effects and features of the disclosure, and methods for achieving them will be clarified with reference to embodiments described below in detail with reference to the drawings. However, the disclosure is not limited to the following embodiments and may be embodied in various forms.

Although the terms “first,” “second,” etc. may be used to describe various elements, these elements should not be limited by these terms. These terms are only used to distinguish one element from another.

As used herein, the singular forms “a,” “an,” and “the” are intended to include the plural forms as well, unless the context clearly indicates otherwise.

It will be understood that the terms “including,” and “having,” are intended to indicate the existence of the features or elements described in the specification, and are not intended to preclude the possibility that one or more other features or elements may exist or may be added.

It will be further understood that, when a layer, region, or element is referred to as being “on” another layer, region, or element, it may be directly on the other layer, region, or element, or may be indirectly on the other layer, region, or element with intervening layers, regions, or elements therebetween.

Sizes of elements in the drawings may be exaggerated or reduced for convenience of explanation. For example, because sizes and thicknesses of elements in the drawings are arbitrarily illustrated for convenience of explanation, the disclosure is not limited thereto.

“A and/or B” is used herein to select only A, select only B, or select both A and B. Also, “at least one of A and B” is used herein to select only A, select only B, or select both A and B.

In the following embodiments, when X and Y are connected to each other, it may include a case where X and Y are electrically connected to each other, a case where X and Y are functionally connected to each other, and a case where X and Y are physically connected to each other, with or without at least one intervening element. X and Y may be objects (e.g., apparatuses, devices, circuits, wirings, electrodes, terminals, conductive films, or layers). Accordingly, a connection relationship is not limited to a certain connection relationship, for example, a connection relationship as shown in the drawings or described in the detailed description, and may include other connection relationships than the connection relationship shown in the drawings or described in the detailed description.

For example, when X and Y are electrically connected, X and Y may be connected to each other directly, or one or more elements (e.g., switches, transistors, capacitors, inductors, resistors, or diodes) that enable electrical connection between X and Y may be connected between X and Y.

In the following embodiments, the term “on” used in association with a device state may refer to a state in which a device is activated, and the term “off” may refer to a state in which a device is deactivated. The term “on” used in association with a signal received by a device may refer to a signal for activating a device, and the term “off” may refer to a signal for deactivating a device. A device may be activated by a high-level voltage or a low-level voltage. For example, a P-type transistor (P channel transistor) is activated by a low-level voltage, and an N-type transistor (N channel transistor) is activated by a high-level voltage. Accordingly, it should be understood that “on” voltages for the P-type transistor and the N-type transistor have opposite (high and low) voltage levels. Hereinafter, a voltage for activating (turning on) a transistor is referred to as an on voltage, and a voltage for deactivating (turning off) a transistor is referred to as an off voltage. A period during which an on voltage of a signal is maintained is referred to as an on voltage period, and a period during which an off voltage is maintained is referred to as an off voltage period.

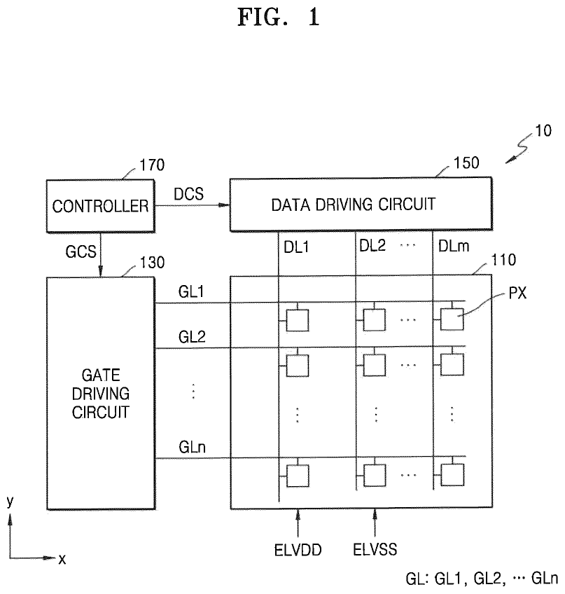

FIG. 1 is a diagram schematically illustrating a display apparatus, according to an embodiment.

A display apparatus 10 according to an embodiment may be a display apparatus such as an organic light-emitting display apparatus, an inorganic light-emitting display apparatus (or an inorganic electroluminescent (EL) display apparatus), and a quantum dot light-emitting display apparatus.

Referring to FIG. 1, the display apparatus 10 according to an embodiment may include a pixel area 110, a gate driving circuit 130, a data driving circuit 150, and a controller 170.

In the pixel area 110, a plurality of pixels PX and signal lines for inputting electrical signals to the plurality of pixels PX may be located.

The plurality of pixels PX may be repeatedly arranged in a first direction (an x-direction or a row direction) and a second direction (a y-direction or a column direction). The plurality of pixels PX may be arranged in any of various forms such as a stripe arrangement, a pentile arrangement, a diamond arrangement, and a mosaic arrangement, to display an image. Each of the plurality of pixels PX may include an organic light-emitting diode as a display element, and the organic light-emitting diode may be connected to a pixel circuit. The pixel circuit may include a plurality of transistors and at least one capacitor.

In an embodiment, the plurality of transistors included in the pixel area 110 may be P-type silicon transistors. The silicon transistor may include a silicon semiconductor, and the silicon semiconductor may include amorphous silicon or polysilicon. For example, the silicon transistor may be a low-temperature polycrystalline silicon (LTPS) thin film transistor.

In an embodiment, the plurality of transistors included in the pixel circuit may be N-type oxide transistors. The oxide transistor may include an oxide semiconductor, and the oxide semiconductor may include a Zn oxide based material such as Zn oxide, In—Zn oxide, and Ga—In—Zn oxide. In some embodiments, the oxide semiconductor may be an In—Ga—Zn—O (IGZO) semiconductor. In some embodiments, the oxide semiconductor may be an In—Sn—Ga—Zn—O (ITGZO) semiconductor. For example, the oxide transistor may be a low-temperature polycrystalline oxide (LTPO) thin film transistor. In an embodiment, some of the plurality of transistors included in the pixel circuit may be P-type silicon transistors and others may be N-type oxide transistors.

The signal lines for inputting electrical signals to the plurality of pixels PX may include a plurality of gate lines GL1 to GLn extending in the first direction and a plurality of data lines DL1 to DLm extending in the second direction. The plurality of gate lines GL1 to GLn may be spaced apart from each other in the second direction and may transmit gate signals to the pixels PX. The plurality of data lines DL1 to DLm may be spaced apart from each other in the first direction and may transmit data signals to the pixels PX. Each of the plurality of pixels PX may be connected to at least one corresponding gate line from among the plurality of gate lines GL1 to GLn and a corresponding data line from among the plurality of data lines DL1 to DLm. Each pixel PX may receive a gate signal applied through a corresponding gate line of the gate lines GL1 to GLn and a data signal from a corresponding data line of the data lines DL1 to DLm.

The gate driving circuit 130 may be connected to the gate lines GL1 to GLn, may generate gate signals in response to a gate driving control signal GCS from the controller 170, and may sequentially supply the gate signals to the gate lines GL1 to GLn. The gate lines GL1 to GLn may each be connected to a gate of a transistor included in the pixel PX, and a gate signal may be a gate control signal for controlling turn-on and turn-off a transistor to which the gate line is connected. A gate signal may include a gate-on voltage at which a transistor may be turned on and a gate-off voltage at which the transistor may be turned off.

The gate driving circuit 130 may include a shift register for sequentially generating and outputting gate signals. In an embodiment, the gate driving circuit 130 may include a plurality of shift registers connected with each other in series and outputting gate signals sequentially such that a current shift register receives an output signal of a preceding shift register as a start signal or a reset signal.

The data driving circuit 150 may be connected to the plurality of data lines DL1 to DLm, and may supply data signals to the data lines DL1 to DLm in response to a data driving control signal DCS from the controller 170. The data signals supplied to the data lines DL1 to DLm may be supplied to the pixels PX to which gate signals are supplied.

In an embodiment, the display apparatus is an organic light-emitting display apparatus. A first power supply voltage ELVDD and a second power supply voltage ELVSS may be supplied to the pixels PX of the pixel area 110. The first power supply voltage ELVDD may be a high-level voltage provided to one terminal of a driving transistor included in each pixel PX. The second power supply voltage ELVSS may be a low-level voltage provided to a second electrode (counter electrode or cathode) of an organic light-emitting diode connected to the other terminal of the driving transistor. The first power supply voltage ELVDD and the second power supply voltage ELVSS may be driving voltages for causing the plurality of pixels PX to emit light.

The controller 170 may generate the gate driving control signal GCS and the data driving control signal DCS based on signals input from the outside. The controller 170 may supply the gate riving control signal GCS to the gate driving circuit 130, and may supply the data driving control signal DCS to the data driving circuit 150.

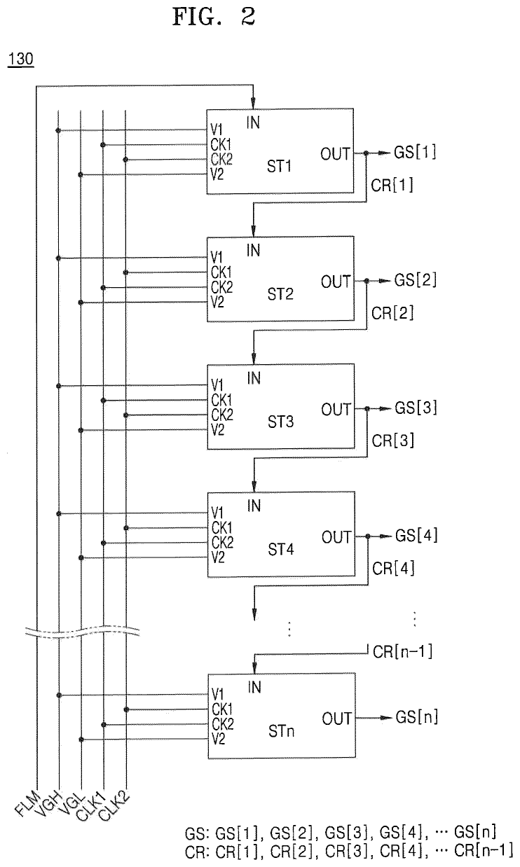

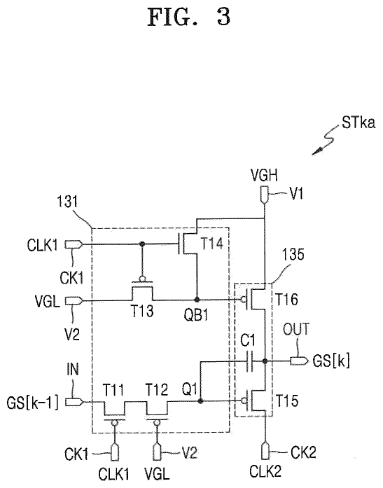

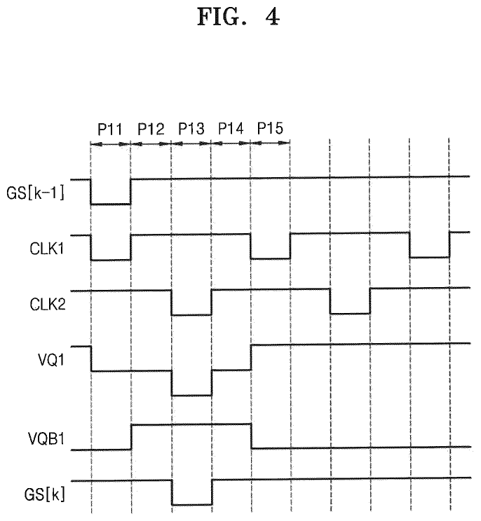

FIG. 2 is a diagram illustrating a gate driving circuit according to an embodiment. FIG. 3 is a circuit diagram illustrating an example of a stage included in the gate driving circuit of FIG. 2. FIG. 4 is a timing diagram for describing an operation of the stage of FIG. 3.

Referring to FIG. 2, the gate driving circuit 130 may include a plurality of stages (e.g., ST1 to STn). The plurality of stages (e.g., ST1 to STn) may sequentially output gate signals GS[1] to GS[n] to the gate lines GL1 to GLn. The number of stages provided in the gate driving circuit 130 may vary according to the number of rows (horizontal lines) provided in the pixel area 110.

Each of first to n^{th} stages ST1 to STn may be connected to a gate line located in a corresponding row of the pixel area 110. Each of the first to n^{th} stages ST1 to STn may receive at least one clock signal and at least one voltage signal, may generate a gate signal GS, and may output the gate signal GS to a connected gate line GL. For example, each of the first to n^{th} stages ST1 to STn may supply a corresponding gate signal GS to the gate line GL provided in a corresponding row.

The first to n^{th} stages ST1 to STn may respectively output first to n^{th} gate signals GS[1], GS[2], GS[3], GS[4], . . . , and GS[n] in response to start signals. For example, the n^{th} stage STn may output the n^{th} gate signal GS[n] to an n^{th} gate line. An external signal FLM that is a start signal for controlling a timing of the first gate signal GS[1] may be supplied to the first stage ST1. In an embodiment, each of the plurality of stages ST1 to STn may be a shift register and include a first stage ST1, a last stage STn, and a plurality of intervening stages ST2 to ST(n−1) which are connected with each other in series. The intervening stages ST2 to ST(n−1) may be connected with each other in series. The first stage ST1 may start an operation by the external signal FLM which serves as the start signal of the first stage ST1. The second stage ST2 in the intervening stages ST2 to ST(n−1) may be directly connected to the first stage ST1 and may receive an output signal of the first stage ST1 as the start signal of the second stage ST2. The output signal of the first stage ST1 may correspond to a gate signal GS[1], which is transmitted to the second stage ST2 as a first carry signal CR[1]. An output signal of the second stage ST2 may be transmitted to a third stage ST3 which is directly connected to the second stage ST2. The output signal of the second stage ST2 may be a second gate signal GS[2], which is transmitted to the third stage ST3 as a second carry signal CR[2]. In response to the second carry signal CR[2], the third stage ST3 may start an operation. This description may apply to the other stages ST4 to STn. The external signal FLM and the carry signals CR[1] to CR[n−1] may serve as start signals to the stages ST1 to STn, respectively. The carry signals CR[1] to CR[n−1] will be further described below. Each of the first to n^{th} stages ST1 to STn may include a plurality of terminals to which a plurality of signals are input. The plurality of signals may include a clock signal and a voltage signal. The plurality of terminals may include an input terminal IN, a first voltage input terminal V1, a second voltage input terminal V2, a first clock terminal CK1, a second clock terminal CK2, and an output terminal OUT.

The start signal may be input (supplied) to the input terminal IN. The start signal may be the external signal FLM or any of the carry signals CR[1], CR[2], CR[3], CR[4], . . . , and CR[n−1]. In an embodiment, each of the carry signals CR[1], CR[2], CR[3], CR[4], . . . , and CR[n−1] may be a gate signal output from a previous stage (hereinafter, referred to as a ‘previous gate signal’). The external signal FLM may be input as a start signal to the input terminal IN of the first stage ST1, and a previous gate signal may be input as a start signal to the input terminal IN of each of the second to n^{th} stages ST2 to STn. A previous stage may be a stage located at least one before a current stage. In FIG. 2, a previous stage is a stage located immediately before a current stage. For example, the third gate signal GS[3] output from the third stage ST3 may be input as a carry signal to the input terminal IN of the fourth stage ST4.

A first voltage VGH may be input to the first voltage input terminal V1, and a second voltage VGL may be input to the second voltage input terminal V2. The second voltage VGL may have a lower voltage level than the first voltage VGH. The first voltage VGH and the second voltage VGL are global signals and may be input from the controller 170 of FIG. 1 or a power supply circuit (not shown). Voltage levels of the first and second voltages VGH and VGL may correspond to voltage levels of on voltages or off voltages of transistors.

A first clock signal CLK1 or a second clock signal CLK2 may be input to the first clock terminal CK1 and the second clock terminal CK2. The first clock signal CLK1 and the second clock signal CLK2 may be alternately input to the first clock terminals CK1 of the first to n^{th} stages ST1 to STn. The second clock signal CLK2 and the first clock signal CLK1 may be alternately input to the second clock terminals CK2 of the first to n^{th} stages ST1 to STn. For example, the first clock signal CLK1 and the second clock signal CLK2 may be respectively input to the first clock terminal CK1 and the second clock terminal CK2 of odd-numbered stages (e.g., ST1, ST3, . . . ). The second clock signal CLK2 and the first clock signal CLK1 may be respectively input to the first clock terminal CK1 and the second clock terminal CK2 of even-numbered stages (e.g., ST2, ST4, . . . ). For example, the first clock signal CLK1 may be supplied to the first clock terminals CK1 of the odd-numbered stages and the second clock terminals CK2 of the even-numbered stages. The second clock signal CLK2 may be supplied to the second clock terminals CK2 of the odd-numbered stages and the first clock terminals CK1 of the even-numbered stages.

As shown in FIG. 4, the first clock signal CLK1 and the second clock signal CLK2 may be square wave signals in which a high-level voltage and a low-level voltage are repeated. The high-level voltage may correspond to a turn-on voltage for N-type transistors or a turn-off voltage for P-type transistors. The low-level voltage may correspond to a turn-off voltage for N-type transistors or a turn-on voltage for P-type transistors. In an embodiment, the first clock signal CLK1 and the second clock signal CLK2 may be square wave signals in which the first voltage VGH and the second voltage VGL are repeated. The first voltage VGH may correspond to a turn-on voltage for N-type transistors or a turn-off voltage for P-type transistors. The second voltage VGL may correspond to a turn-off voltage for N-type transistors or a turn-on voltage for P-type transistors. The first clock signal CLK1 and the second clock signal CLK2 may have the same waveform and may be phase-shifted signals. For example, the second clock signal CLK2 may have the same waveform as the first clock signal CLK1 and may be input with its phase shifted (delayed) at certain intervals. The second clock signal CLK2 may be half-cycle shifted with respect to the first clock signal CLK1.

As shown in FIG. 4, in the first clock signal CLK1 and the second clock signal CLK2, a period during which a high-level voltage is maintained for one cycle may be longer than a period during which a low-level voltage is maintained. An embodiment is not limited thereto. For example, in the first clock signal CLK1 and the second clock signal CLK2, a period during which a high-level voltage is maintained for one cycle may be the same as a period during which a low-level voltage is maintained.

A gate signal may be output from the output terminal OUT. The first to n^{th} gate signals GS[1], GS[2], GS[3], GS[4], . . . , and GS[n] respectively output from the output terminals OUT of the first to n^{th} stages ST1 to STn may be sequentially shifted by a certain period of time. Each gate signal may be supplied to a pixel through a corresponding output line, for example, a gate line.

Hereinafter, a k^{th} stage STka (where k is a natural number greater than 0) corresponding to a k^{th} row of the pixel area 110 will be described as an example. The k^{th} stage STka may receive a (k−1)^{th} gate signal GS[k−1] (hereinafter, referred to as a previous gate signal GS[k−1]) as a start signal from a (k−1)^{th} stage that is a previous stage, may output a k^{th} gate signal GS[k] to a gate line of a k^{th} row, and may output the k^{th} gate signal GS[k] as a carry signal to a (k+1)^{th} stage that is a next stage.

In an odd-numbered stage, the first clock terminal CK1 may receive the first clock signal CLK1, and the second clock terminal CK2 may receive the second clock signal CLK2. In an even-numbered stage, the first clock terminal CK1 may receive the second clock signal CLK2, and the second clock terminal CK2 may receive the first clock signal CLK1. For convenience of explanation, the following will be described assuming that the k^{th} stage STka (hereinafter, referred to as the stage STka) is an odd-numbered stage, the first clock signal CLK1 is input to the first clock terminal CK1, and the second clock signal CLK2 is input to the second clock terminal CK2. When k is 1, that is, the first stage ST1 may receive the external signal FLM as a start signal through the input terminal IN.

Hereinafter, the first voltage VGH may be expressed as a high-level voltage, and the second voltage VGL may be expressed as a low-level voltage. A low level may be expressed as a first voltage level, and a high level may be expressed as a second voltage level. The first voltage VGH may correspond to a turn-on voltage for N-type transistors or a turn-off voltage for P-type transistors. The second voltage VGL may correspond to a turn-off voltage for N-type transistors or a turn-on voltage for P-type transistors.

Referring to FIG. 3, a stage STka may include a control circuit 131 and an output circuit 135. Each of the control circuit 131 and the output circuit 135 may include at least one transistor. The at least one transistor may include an N-type transistor and/or a P-type transistor. For example, a first transistor T11, a second transistor T12, a third transistor T13, a fifth transistor T15, and a sixth transistor T16 of the stage STka may be P-type transistors, and a fourth transistor T14 may be an N-type transistor. A gate-on voltage of the P-type transistor may be a low-level voltage, and a gate-off voltage of the P-type transistor may be a high-level voltage. A gate-on voltage of the N-type transistor may be a high-level voltage, and a gate-off voltage of the N-type transistor may be a low-level voltage.

The control circuit 131 may control voltages of a first node Q1 and a second node QB1 in response to signals input to the input terminal IN and the first clock terminal CK1. For example, the control circuit 131 may control voltages of the first node Q1 and the second node QB1 in response to a start signal (e.g., the external signal FLM (see FIG. 2) or a carry signal CR (see FIG. 2)) and the first clock signal CLK1. In an embodiment, the carry signal CR may be a previous gate signal GS[k−1]. The control circuit 131 may include the first to fourth transistors T11 to T14.

The first transistor T11 may be connected between the input terminal IN and the first node Q1. The first transistor T11 may be connected between the input terminal IN and the second transistor T12. A gate of the first transistor T11 may be connected to the first clock terminal CK1. The first transistor T11 may be turned on when the first clock signal CLK1 input to the first clock terminal CK1 is at a low level and may transmit a start signal input to the input terminal IN to the first node Q1.

The second transistor T12 may be connected between the input terminal IN and the first node Q1. The second transistor T12 may be connected between the first transistor T11 and the first node Q1. A gate of the second transistor T12 may be connected to the second voltage input terminal V2. The second transistor T12 may be turned on by the second voltage VGL input to the second voltage input terminal V2 and may transmit a start signal input through the first transistor T11 to the first node Q1. The second transistor T12 may always be in a turned-on state, and the input terminal IN may be selectively and electrically connected to the first node Q1 depending on a voltage level of the first clock signal CLK1. Because the second transistor T12 shares stress caused by a multi-step voltage change of the first node Q1 with the first transistor T11, stress on the first transistor T11 may be relieved compared to a stage in which the second transistor T12 is omitted and the first transistor T11 is provided alone. Also, when the first transistor T11 is turned off, a line voltage drop between the input terminal IN and the first node Q1 may be prevented by the second transistor T12.

The third transistor T13 may be connected between the second voltage input terminal V2 and the second node QB1. A gate of the third transistor T13 may be connected to the first clock terminal CK1. The third transistor T13 may be turned on when the first clock signal CLK1 input to the first clock terminal CK1 is at a low level and may transmit the second voltage VGL input to the second voltage input terminal V2 to the second node QB1. Because the second voltage VGL, which is a constant voltage, rather than a carry signal, is used as a low-level voltage of the second node QB1 through the third transistor T13, high-level gate signal output may be reliably ensured regardless of carry signal defects.

The fourth transistor T14 may be connected between the first voltage input terminal V1 and the second node QB1. A gate of the fourth transistor T14 may be connected to the first clock terminal CK1. The fourth transistor T14 may be turned on when the first clock signal CLK1 input to the first clock terminal CK1 is at a high level and may transmit the first voltage VGH input to the first voltage input terminal V1 to the second node QB1.

The output circuit 135 may be connected between the first voltage input terminal V1 and the second clock terminal CK2. The output circuit 135 may output a gate signal GS[k] of one of a high-level voltage and a low-level voltage according to voltage levels of the first node Q1 and the second node QB1. The output circuit 135 may include the fifth transistor T15 and the sixth transistor T16. The output circuit 135 may further include a capacitor C1.

The fifth transistor T15 may be connected between the output terminal OUT and the second clock terminal CK2. A gate of the fifth transistor T15 may be connected to the first node Q1. The fifth transistor T15 may be a pull-down transistor that transmits a low-level voltage to the output terminal OUT. The fifth transistor T15 may be turned on when the first node Q1 is at a low level and may transmit the second clock signal CLK2 input to the second clock terminal CK2 to the output terminal OUT.

The sixth transistor T16 may be connected between the first voltage input terminal V1 and the output terminal OUT. A gate of the sixth transistor T16 may be connected to the second node QB1. The sixth transistor T16 may be a pull-up transistor that transmits a high-level voltage to the output terminal OUT. The sixth transistor T16 may be turned on when the second node QB1 is at a low level and may transmit the first voltage VGH of a high-level voltage input to the first voltage input terminal V1 to the output terminal OUT.

The capacitor C1 may be connected between the first node Q1 and the output terminal OUT. When the first transistor T11 is turned off, a voltage level of the first node Q1 may be maintained by the capacitor C1. When a voltage level at the output terminal OUT is changed from a high level to a low level, a low-level voltage of the first node Q1 may be changed to a lower low-level voltage by the capacitor C1.

Hereinafter, an operation of the stage STka of FIG. 3 will be described with reference to FIG. 4. In FIG. 4, the previous gate signal GS[k−1] as a start signal, the first clock signal CLK1, the second clock signal CLK2, a voltage VQ1 of the first node Q1, a voltage VQB1 of the second node QB1, and the gate signal GS[k] as an output signal are illustrated.

In a first interval P11, the previous gate signal GS[k−1] of a low level may be supplied from a previous stage to the input terminal IN, the first clock signal CLK1 of a low level may be supplied to the first clock terminal CK1, and the second clock signal CLK2 of a high level may be supplied to the second clock terminal CK2.

The first transistor T11 and the third transistor T13 may be turned on by the first clock signal CLK1 of a low level. The second transistor T12 may be in a turned-on state due to the second voltage VGL of a low level.

The previous gate signal GS[k−1] of a low level may be transmitted to the first node Q1 by the first transistor T11 and the second transistor T12 that are turned on and a voltage VQ1 of the first node Q1 may be a low-level voltage. Accordingly, the fifth transistor T15 may be turned on, and the second clock signal CLK2 of a high level may be transmitted to the output terminal OUT.

The second voltage VGL of a low level may be transmitted to the second node QB1 by the third transistor T13 that is turned on, and a voltage VQB1 of the second node QB1 may be a low-level voltage. Accordingly, the sixth transistor T16 may be turned on, and the first voltage VGH of a high level may be transmitted to the output terminal OUT.

Accordingly, the gate signal GS[k] of a high level may be output from the output terminal OUT. A voltage difference between the output terminal OUT and the first node Q1 may be stored in the capacitor C1. In an embodiment, the first and second clock signals CLK1 and CLK2 may have a high level corresponding to the first voltage VGH of a high level and a low level corresponding to the second voltage VGL of a low level. The gate signal GS[k] has a high level corresponding to the first voltage VGH in the first interval P11. The voltage difference between the output terminal OUT and the first node Q1 may correspond to a value of |VGH−VGL| in the first interval P11.

In a second interval P12, the previous gate signal GS[k−1] of a high level may be supplied to the input terminal IN, the first clock signal CLK1 of a high level may be supplied to the first clock terminal CK1, and the second clock signal CLK2 of a high level may be supplied to the second clock terminal CK2.

The first transistor T11 and the third transistor T13 may be turned off by the first clock signal CLK1 of a high level, and the fourth transistor T14 may be turned on. The second transistor T12 may be in a turned-on state due to the second voltage VGL of a low level.

The first voltage VGH of a high level may be transmitted to the second node QB1 by the fourth transistor T14 that is turned on, and a voltage VQB1 of the second node QB1 may be a high-level voltage. Accordingly, the sixth transistor T16 may be turned off.

Because the first node Q1 maintains a low-level voltage in the first interval P11 due to the capacitor C1, a turned-on state of the fifth transistor T15 may be maintained, and thus, the second clock signal CLK2 of a high level may be transmitted to the output terminal OUT. Accordingly, the gate signal GS[k] of a high level may be output from the output terminal OUT.

In a third interval P13, the previous gate signal GS[k−1] of a high level may be supplied to the input terminal IN, the first clock signal CLK1 of a high level may be supplied to the first clock terminal CK1, and the second clock signal CLK2 of a low level may be supplied to the second clock terminal CK2.

Because the first clock signal CLK1 maintains a high level, a turned-off state of the first transistor T11 and the third transistor T13 may be maintained and a turned-on state of the fourth transistor T14 may be maintained. The second transistor T12 may be in a turned-on state due to the second voltage VGL of a low level.

The first voltage VGH of a high level may be transmitted to the second node QB1 by the fourth transistor T14 that is turned on, and a voltage VQB1 of the second node QB1 may be a high-level voltage. Accordingly, the sixth transistor T16 may be turned off.

The second clock signal CLK2 of a low level may be transmitted to the output terminal OUT through the fifth transistor T15 whose turned-on state is maintained. Accordingly, the gate signal GS[k] of a low level may be output from the output terminal OUT. As a voltage of the output terminal OUT falls from a high level to a low level, a voltage VQ1 of the first node Q1 may fall to a voltage level lower than a voltage level in the second interval P12 due to coupling of the capacitor C1. In an embodiment, the first and second clock signals CLK1 and CLK2 may have a high level corresponding to the first voltage VGH of a high level and a low level corresponding to the second voltage VGL of a low level. In the second interval P12, no charging or discharging by the input terminal IN due to the turned-off first transistor T11 occurs to the capacitor C1, and thus the capacitor C1 keeps the voltage difference of |VGH-VGL|. In the third interval P13, a voltage of the output terminal OUT that is an electrode of the capacitor C1 decreases from the first voltage VGH to the second voltage VGL, and thus a voltage of the other electrode of the capacitor C1 which corresponds to the first node Q1 decreases from the second voltage VGL to a lower voltage than the second voltage VGL.

In a fourth interval P14, the previous gate signal GS[k−1] of a high level may be supplied to the input terminal IN, the first clock signal CLK1 of a high level may be supplied to the first clock terminal CK1, and the second clock signal CLK2 of a high level may be supplied to the second clock terminal CK2.

Because the first clock signal CLK1 maintains a high level, a turned-off state of the first transistor T11 and the third transistor T13 may be maintained and a turned-on state of the fourth transistor T14 may be maintained. The second transistor T12 may be in a turned-on state due to the second voltage VGL of a low level.

The first voltage VGH of a high level may be transmitted to the second node QB1 by the fourth transistor T14 that is turned on, and a voltage VQB1 of the second node QB1 may be a high-level voltage. Accordingly, the sixth transistor T16 may be turned off.

The second clock signal CLK2 of a high level may be transmitted to the output terminal OUT through the fifth transistor T15 whose turned-on state is maintained. Accordingly, the gate signal GS[k] of a high level may be output from the output terminal OUT. As a voltage of the output terminal OUT rises from a low level to a high level, a voltage VQ1 of the first node Q1 may rise to a low level (e.g., about a voltage level in the second interval P12) higher than a voltage level in the third interval P13 due to coupling of the capacitor C1. In an embodiment, the first and second clock signals CLK1 and CLK2 may have a high level corresponding to the first voltage VGH and a low level corresponding to the second voltage VGL. In the third interval P13, no charging or discharging by the input terminal IN due to the turned-off first transistor T11 occurs to the capacitor C1, and thus the capacitor C1 keeps the voltage difference corresponding to a value of |VGH−VGL|. In the fourth interval P14, a voltage of the output terminal OUT that is an electrode of the capacitor C1 increases from the second voltage VGL to the first voltage VGH, and thus a voltage of the other electrode of the capacitor C1 which corresponds to the first node Q1 increases from the lower voltage than the second voltage VGL to the second voltage VGL.

In a fifth interval P15, the previous gate signal GS[k−1] of a high level may be supplied to the input terminal IN, the first clock signal CLK1 of a low level may be supplied to the first clock terminal CK1, and the second clock signal CLK2 of a high level may be supplied to the second clock terminal CK2.

The first transistor T11 and the third transistor T13 may be turned on by the first clock signal CLK1 of a low level, and the fourth transistor T14 may be turned off. The second transistor T12 may be in a turned-on state due to the second voltage VGL of a low level.

The previous gate signal GS[k−1] of a high level may be transmitted to the first node Q1 by the first transistor T11 and the second transistor T12 that are turned on, and a voltage VQ1 of the first node Q1 may be a high-level voltage. Accordingly, the fifth transistor T15 may be turned off.

The second voltage VGL of a low level may be transmitted to the second node QB1 by the third transistor T13 that is turned on, and a voltage VQB1 of the second node QB1 may be a low-level voltage. Accordingly, the sixth transistor T16 may be turned on, and the first voltage VGH of a high level may be transmitted to the output terminal OUT. Accordingly, the gate signal GS[k] of a high level may be output from the output terminal OUT. In an embodiment, the first and second clock signals CLK1 and CLK2 may have a high level corresponding to the first voltage VGH and a low level corresponding to the second voltage VGL. In the fifth interval P15, discharging by the input terminal IN due to the turned-on first transistor T11 occurs to the capacitor C1, and since a voltage of the output terminal OUT and a voltage VQ1 of the first node Q1 are the same, no charges are stored in the capacitor C1 in the fifth interval P15.

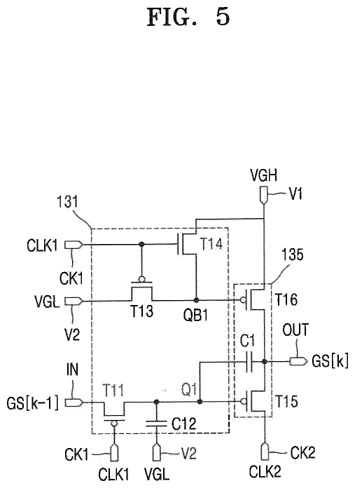

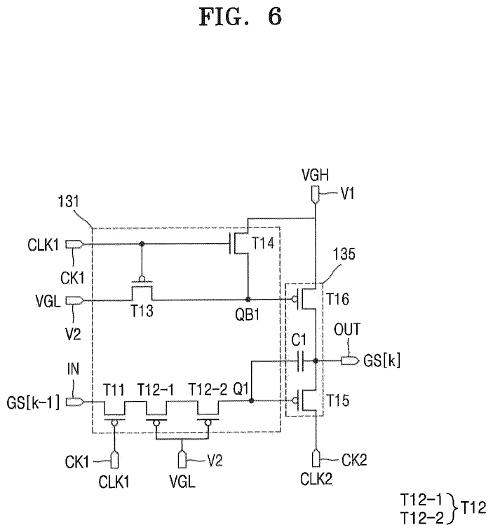

FIGS. 5 and 6 are circuit diagrams illustrating an example of a stage included in the gate driving circuit of FIG. 2. Hereinafter, a difference from the stage of FIG. 3 will be mainly described.

The stage of FIG. 5 is different from the stage STka of FIG. 3 in that the second transistor T12 is omitted and a capacitor C12 is provided, and other elements and operations are the same as those of the stage STka of FIG. 3. The capacitor C12 may be connected between the first node Q1 and the second voltage input terminal V2. Stress on the first transistor T11 due to a multi-step voltage change of the first node Q1 may be relieved by the capacitor C12.

The stage of FIG. 6 is different from the stage STka of FIG. 3 in that the second transistor T12 has a structure in which a plurality of sub-transistors are connected with each other in series, and other elements and operations are the same as those of the stage STka of FIG. 3. The second transistor T12 may include a plurality of sub-transistors connected in series between the first transistor T11 and the first node Q1. The sub-transistors may include one pair of sub-transistors (i.e., a first sub-transistor T12-1 and a second sub-transistor T12-2). Gates of the first sub-transistor T12-1 and the second sub-transistor T12-2 may be connected to the second voltage input terminal V2. The first sub-transistor T12-1 and the second sub-transistor T12-2 may always be in a turned-on state due to the second voltage VGL input to the second voltage input terminal V2.

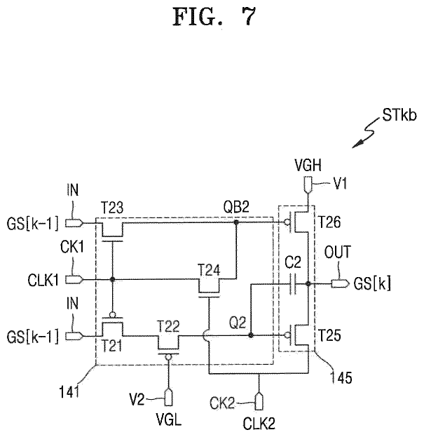

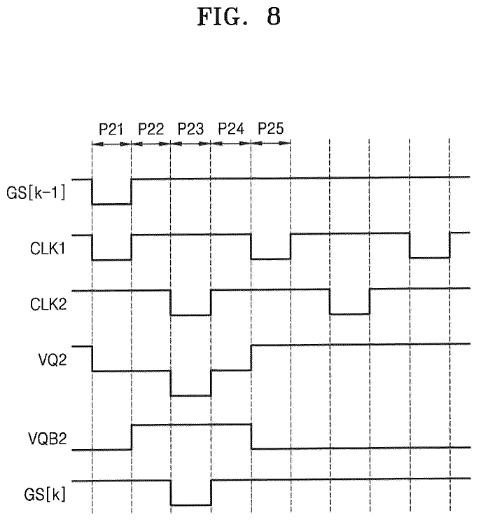

FIG. 7 is a circuit diagram illustrating an example of a stage included in the gate driving circuit of FIG. 2. FIG. 8 is a timing diagram for describing an operation of the stage of FIG. 7.

The stage of FIG. 7 is a k^{th} stage STkb (where k is a natural number greater than 0) corresponding to a k^{th} row of the pixel area 110, and may receive a (k−1)^{th} gate signal GS[k−1] as a start signal from a (k−1)^{th} stage that is a previous stage, may output a k^{th} gate signal GS[k] to a gate line of a k^{th} row, and may output the k^{th} gate signal GS[k] as a carry signal to a (k+1)^{th} stage that is a next stage.

The stage STkb may include a control circuit 141 and an output circuit 145. Each of the control circuit 141 and the output circuit 145 may include at least one transistor. The at least one transistor may include an N-type transistor and/or a P-type transistor. For example, a first transistor T21, a second transistor T22, a fifth transistor T25, and a sixth transistor T26 of the stage STkb may be P-type transistors, and a third transistor T23 and a fourth transistor T24 may be N-type transistors.

The control circuit 141 may control voltages of a first node Q2 and a second node QB2 in response to signals input to the input terminal IN, the first clock terminal CK1, and the second clock terminal CK2. For example, the control circuit 141 may control voltages of the first node Q2 and the second node QB2 in response to a start signal (e.g., the external signal FLM (see FIG. 2) or the carry signal CR (see FIG. 2)), the first clock signal CLK1 and the second clock signal CLK2. In an embodiment, the carry signal CR may be a previous gate signal GS[k−1]. The control circuit 141 may include the first to fourth transistors T21 to T24.

The first transistor T21 may be connected between the input terminal IN and the first node Q2. The first transistor T21 may be connected between the input terminal IN and the second transistor T22. A gate of the first transistor T21 may be connected to the first clock terminal CK1. The first transistor T21 may be turned on when the first clock signal CLK1 input to the first clock terminal CK1 is at a low level and may transmit a start signal input to the input terminal IN to the first node Q2.

The second transistor T22 may be connected between the input terminal IN and the first node Q2. The second transistor T22 may be connected between the first transistor T21 and the first node Q2. A gate of the second transistor T22 may be connected to the second voltage input terminal V2. The second transistor T22 may be turned on by the second voltage VGL input to the second voltage input terminal V2 and may transmit a start signal input through the first transistor T21 to the first node Q2. The second transistor T22 may always be in a turned-on state. Because the second transistor T22 shares stress caused by a multi-step voltage change of the first node Q2 with the first transistor T21, stress on the first transistor T21 may be relieved compared to a stage in which the second transistor T22 is omitted and the first transistor T21 is provided alone. Also, when the first transistor T21 is turned off, a line voltage drop between the input terminal IN and the first node Q2 may be prevented by the second transistor T22.

The third transistor T23 may be connected between the input terminal IN and the second node QB2. A gate of the third transistor T23 may be connected to the first clock terminal CK1. The third transistor T23 may be turned on when the first clock signal CLK1 input to the first clock terminal CK1 is at a high level and may transmit a start signal input to the input terminal IN to the second node QB2.

The fourth transistor T24 may be connected between the first clock terminal CK1 and the second node QB2. A gate of the fourth transistor T24 may be connected to the second clock terminal CK2. The fourth transistor T24 may be turned on when the second clock signal CLK2 input to the second clock terminal CK2 is at a high level and may transmit the first clock signal CLK1 input to the first clock terminal CK1 to the second node QB2.

The output circuit 145 may be connected between the first voltage input terminal V1 and the second clock terminal CK2. The output circuit 145 may output the gate signal GS[k] of one of a high-level voltage and a low-level voltage according to voltage levels of the first node Q2 and the second node QB2. The output circuit 145 may include the fifth transistor T25 and the sixth transistor T26. The output circuit 145 may further include a capacitor C2.

The fifth transistor T25 may be connected between the output terminal OUT and the second clock terminal CK2. A gate of the fifth transistor T25 may be connected to the first node Q2. The fifth transistor T25 may be a pull-down transistor that transmits a low-level voltage to the output terminal OUT. The fifth transistor T25 may be turned on when the first node Q2 is at a low level and may transmit the second clock signal CLK2 input to the second clock terminal CK2 to the output terminal OUT.

The sixth transistor T26 may be connected between the first voltage input terminal V1 and the output terminal OUT. A gate of the sixth transistor T26 may be connected to the second node QB2. The sixth transistor T26 may be a pull-up transistor that transmits a high-level voltage to the output terminal OUT. The sixth transistor T26 may be turned on when the second node QB2 is at a low level and may output the first voltage VGH of a high-level voltage input to the first voltage input terminal V1 to the output terminal OUT.

The capacitor C2 may be connected between the output terminal OUT and the first node Q2. When the first transistor T21 is turned off, a voltage level of the first node Q2 may be maintained by the capacitor C2. When a voltage level at the output terminal OUT is changed from a high level to a low level, a low-level voltage of the first node Q2 may be changed to a lower low-level voltage by the capacitor C2.

Hereinafter, an operation of the stage STkb of FIG. 7 will be described with reference to FIG. 8. In FIG. 8, the previous gate signal GS[k−1] as a start signal, the first clock signal CLK1, the second clock signal CLK2, a voltage VQ2 of the first node Q2, a voltage VQB2 of the second node QB2, and the gate signal GS[k] as an output signal are illustrated.

In a first interval P21, the previous gate signal GS[k−1] of a low level may be supplied from a previous stage to the input terminal IN, the first clock signal CLK1 of a low level may be supplied to the first clock terminal CK1, and the second clock signal CLK2 of a high level may be supplied to the second clock terminal CK2.

The first transistor T21 may be turned on by the first clock signal CLK1 of a low level, and the third transistor T23 may be turned off. The fourth transistor T24 may be turned on by the second clock signal CLK2 of a high level. The second transistor T22 may be in a turned-on state due to the second voltage VGL of a low level.

The previous gate signal GS[k−1] of a low level may be transmitted to the first node Q2 by the first transistor T21 and the second transistor T22 that are turned on, and a voltage VQ2 of the first node Q2 may be a low-level voltage. Accordingly, the fifth transistor T25 may be turned on, and the second clock signal CLK2 of a high level may be transmitted to the output terminal OUT.

The previous gate signal GS[k−1] of a low level may not be transmitted to the second node QB2 by the third transistor T23 that is turned off. The first clock signal CLK1 of a low level may be transmitted to the second node QB2 by the fourth transistor T24 that is turned on by the second clock signal CLK2 of a high level. Accordingly, the sixth transistor T26 may be turned on, and the first voltage VGH of a high level may be transmitted to the output terminal OUT.

Accordingly, the gate signal GS[k] of a high level may be output from the output terminal OUT. A voltage difference between the output terminal OUT and the first node Q2 may be stored in the capacitor C2. In an embodiment, the first and second clock signals CLK1 and CLK2 may have a high level corresponding to the first voltage VGH of a high level and a low level corresponding to the second voltage VGL of a low level. The gate signal GS[k] has a high level corresponding to the first voltage VGH in the first interval P21. The voltage difference between the output terminal OUT and the first node Q2 may correspond to a value of |VGH-VGL| in the first interval P21.

In a second interval P22, the previous gate signal GS[k−1] of a high level may be supplied to the input terminal IN, the first clock signal CLK1 of a high level may be supplied to the first clock terminal CK1, and the second clock signal CLK2 of a high level may be supplied to the second clock terminal CK2.

The first transistor T21 may be turned off by the first clock signal CLK1 of a high level, and the third transistor T23 may be turned on. The fourth transistor T24 may be turned on by the second clock signal CLK2 of a high level. The second transistor T22 may be in a turned-on state due to the second voltage VGL of a low level.

The previous gate signal GS[k−1] of a high level may be transmitted to the second node QB2 by the third transistor T23 that is turned on, the first clock signal CLK1 of a high level may be transmitted to the second node QB2 by the fourth transistor T24 that is turned on, and a voltage VQB2 of the second node QB2 may be a high-level voltage. Accordingly, the sixth transistor T26 may be turned off.

Because the first node Q2 maintains a low-level voltage in the first interval P21 due to the capacitor C2, a turned-on state of the fifth transistor T25 may be maintained, and thus, the second clock signal CLK2 of a high level may be transmitted to the output terminal OUT. Accordingly, the gate signal GS[k] of a high level may be output from the output terminal OUT.

In a third interval P23, the previous gate signal GS[k−1] of a high level may be supplied to the input terminal IN, the first clock signal CLK1 of a high level may be supplied to the first clock terminal CK1, and the second clock signal CLK2 of a low level may be supplied to the second clock terminal CK2.

Because the first clock signal CLK1 maintains a high level, a turned-off state of the first transistor T21 may be maintained, and a turned-on state of the third transistor T23 may be maintained. The fourth transistor T24 may be turned off by the second clock signal CLK2 of a low level. The second transistor T22 may be in a turned-on state due to the second voltage VGL of a low level.

The previous gate signal GS[k−1] of a high level may be transmitted to the second node QB2 by the third transistor T23 that is turned on, and a voltage VQB2 of the second node QB2 may be a high-level voltage. Accordingly, the sixth transistor T26 may be turned off.

The second clock signal CLK2 of a low level may be transmitted to the output terminal OUT through the fifth transistor T25 whose turned-on state is maintained. Accordingly, the gate signal GS[k] of a low level may be output from the output terminal OUT. As a voltage of the output terminal OUT falls from a high level to a low level, a voltage VQ2 of the first node Q2 may fall to a voltage level lower than a voltage level in the second interval P22 due to coupling of the capacitor C2. In an embodiment, the first and second clock signals CLK1 and CLK2 may have a high level corresponding to the first voltage VGH of a high level and a low level corresponding to the second voltage VGL of a low level. In the second interval P22, no charging or discharging by the input terminal IN due to the turned-off first transistor T21 occurs to the capacitor C2, and thus the capacitor C2 keeps the voltage difference of |VGH−VGL|. In the third interval P23, a voltage of the output terminal OUT that is an electrode of the capacitor C2 decreases from the first voltage VGH to the second voltage VGL, and thus a voltage of the other electrode of the capacitor C2 which corresponds to the first node Q2 decreases from the second voltage VGL to a lower voltage than the second voltage VGL.

In a fourth interval P24, the previous gate signal GS[k−1] of a high level may be supplied to the input terminal IN, the first clock signal CLK1 of a high level may be supplied to the first clock terminal CK1, and the second clock signal CLK2 of a high level may be supplied to the second clock terminal CK2.

Because the first clock signal CLK1 maintains a high level, a turned-off state of the first transistor T21 may be maintained, and a turned-on state of the third transistor T23 may be maintained. The fourth transistor T24 may be turned on by the second clock signal CLK2 of a high level. The second transistor T22 may be in a turned-on state due to the second voltage VGL of a low level.

The previous gate signal GS[k−1] of a high level may be transmitted to the second node QB2 by the third transistor T23 that is turned on, the first clock signal CLK1 of a high level may be transmitted to the second node QB2 by the fourth transistor T24 that is turned on, and a voltage VQB2 of the second node QB2 may be a high-level voltage. Accordingly, the sixth transistor T26 may be turned off.

The second clock signal CLK2 of a high level may be transmitted to the output terminal OUT through the fifth transistor T25 whose turned-on state is maintained. Accordingly, the gate signal GS[k] of a high level may be output from the output terminal OUT. As a voltage of the output terminal OUT rises from a low level to a high level, a voltage VQ2 of the first node Q2 may rise to a low level (e.g., about a voltage level in the second interval P22) higher than a voltage level in the third interval P23 due to coupling of the capacitor C2. In an embodiment, the first and second clock signals CLK1 and CLK2 may have a high level corresponding to the first voltage VGH and a low level corresponding to the second voltage VGL. In the third interval P23, no charging or discharging by the input terminal IN due to the turned-off first transistor T21 occurs to the capacitor C2, and thus the capacitor C2 keeps the voltage difference corresponding to a value of |VGH-VGL|. In the fourth interval P24, a voltage of the output terminal OUT that is an electrode of the capacitor C2 increases from the second voltage VGL to the first voltage VGH, and thus a voltage of the other electrode of the capacitor C2 which corresponds to the first node Q2 increases from the lower voltage than the second voltage VGL to the second voltage VGL.

In a fifth interval P25, the previous gate signal GS[k−1] of a high level may be supplied to the input terminal IN, the first clock signal CLK1 of a low level may be supplied to the first clock terminal CK1, and the second clock signal CLK2 of a high level may be supplied to the second clock terminal CK2.

The first transistor T21 may be turned on by the first clock signal CLK1 of a low level, and the third transistor T23 may be turned off. The fourth transistor T24 may be turned on by the second clock signal CLK2 of a high level. The second transistor T22 may be in a turned-on state due to the second voltage VGL of a low level.

The previous gate signal GS[k−1] of a high level may be transmitted to the first node Q2 by the first transistor T21 and the second transistor T22 that are turned on, and a voltage VQ2 of the first node Q2 may be a high-level voltage. Accordingly, the fifth transistor T25 may be turned off.

The first clock signal CLK1 of a low level may be transmitted to the second node QB2 by the fourth transistor T24 that is turned on, and a voltage VQB2 of the second node QB2 may be a low-level voltage. Accordingly, the sixth transistor T26 may be turned on, and the first voltage VGH of a high level may be transmitted to the output terminal OUT. Accordingly, the gate signal GS[k] of a high level may be output from the output terminal OUT. In an embodiment, the first and second clock signals CLK1 and CLK2 may have a high level corresponding to the first voltage VGH and a low level corresponding to the second voltage VGL. In the fifth interval P25, discharging by the input terminal IN due to the turned-on first transistor T21 occurs to the capacitor C2, and since a voltage of the output terminal OUT and a voltage VQ2 of the first node Q2 are the same, no charges are stored in the capacitor C2 in the fifth interval P25.

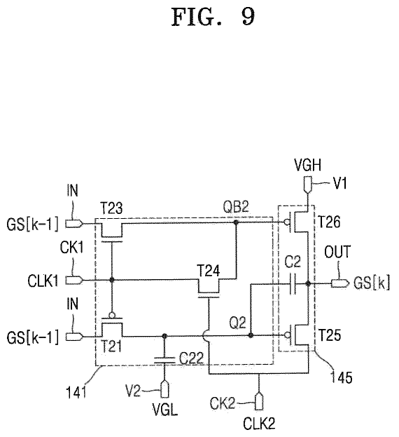

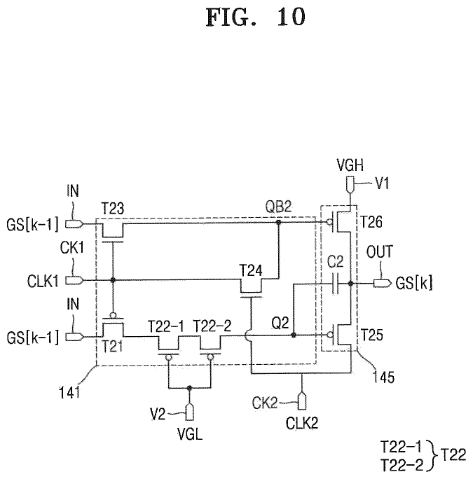

FIGS. 9 and 10 are circuit diagrams illustrating an example of a stage included in the gate driving circuit of FIG. 2. Hereinafter, a difference from the stage of FIG. 7 will be mainly described.

The stage of FIG. 9 is different from the stage STkb of FIG. 7 in that the second transistor T22 is omitted and a capacitor C22 is provided, and other elements and operations are the same as those of the stage STkb of FIG. 7. The capacitor C22 may be connected between the first node Q2 and the second voltage input terminal V2. Stress on the first transistor T21 due to a multi-step voltage change of the first node Q2 may be relieved by the capacitor C22.

The stage of FIG. 10 is different from the stage STkb of FIG. 7 in that the second transistor T22 has a structure in which a plurality of sub-transistors are connected in series, and other elements and operations are the same as those of the stage STkb of FIG. 7. The second transistor T22 may include a plurality of sub-transistors connected in series between the first transistor T21 and the first node Q2. The sub-transistors may include one pair of sub-transistors, i.e., a first sub-transistor T22-1 and a second sub-transistor T22-2. Gates of the first sub-transistor T22-1 and the second sub-transistor T22-2 may be connected to the second voltage input terminal V2. The first sub-transistor T22-1 and the second sub-transistor T22-2 may always be in a turned-on state due to the second voltage VGL input to the second voltage input terminal V2.

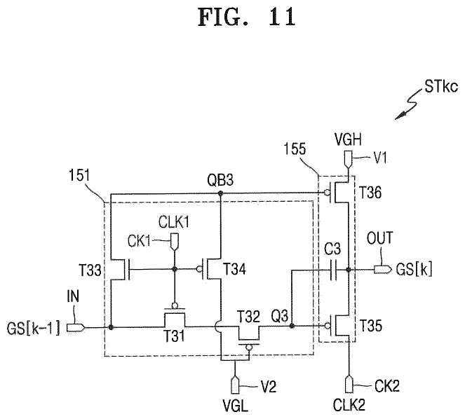

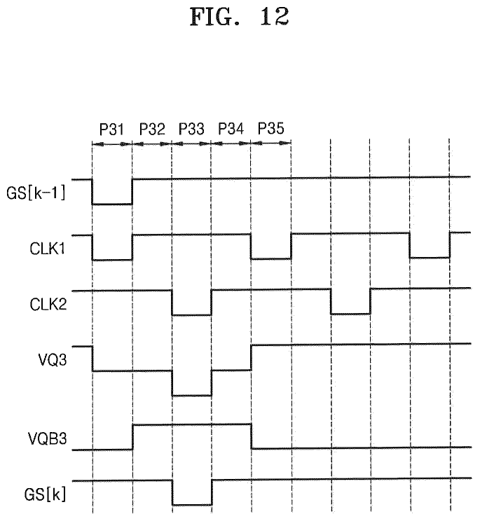

FIG. 11 is a circuit diagram illustrating an example of a stage included in the gate driving circuit of FIG. 2. FIG. 12 is a timing diagram for describing an operation of the stage of FIG. 11.

The stage of FIG. 11 is a k^{th} stage STkc (where k is a natural number greater than 0) corresponding to a k^{th} row of the pixel area 110, and may receive a (k−1)^{th} gate signal GS[k−1] as a start signal from a (k−1)^{th} stage that is a previous stage, may output a k^{th} gate signal GS[k] to a gate line of a k^{th} row, and may output the k^{th} gate signal GS[k] as a carry signal to a (k+1)^{th} stage that is a next stage.

The stage STkc may include a control circuit 151 and an output circuit 155. Each of the control circuit 151 and the output circuit 155 may include at least one transistor. The at least one transistor may include an N-type transistor and/or a P-type transistor. For example, a first transistor T31, a second transistor T32, a fourth transistor T34, a fifth transistor T35, and a sixth transistor T36 of the stage STkc may be P-type transistors, and a third transistor T33 may be an N-type transistor.

The control circuit 151 may control voltages of a first node Q3 and a second node QB3 in response to signals input to the input terminal IN and the first clock terminal CK1. For example, the control circuit 151 may control voltages of the first node Q3 and the second node QB3 in response to a start signal (e.g., the external signal FLM (see FIG. 2) or the carry signal CR (see FIG. 2)) and the first clock signal CLK1. In an embodiment, the carry signal CR may be a previous gate signal GS[k−1]. The control circuit 151 may include the first to fourth transistors T31 to T34. For example, the carry signal CR of a current stage STkc as a start signal may correspond to a gate signal GS[k−1] of a previous stage. A start signal of the first stage ST1 may be the external signal FLM.

The first transistor T31 may be connected between the input terminal IN and the first node Q3. The first transistor T31 may be connected between the input terminal IN and the second transistor T32. A gate of the first transistor T31 may be connected to the first clock terminal CK1. The first transistor T31 may be turned on when the first clock signal CLK1 input to the first clock terminal CK1 is at a low level and may transmit a start signal input to the input terminal IN to the first node Q3.

The second transistor T32 may be connected between the input terminal IN and the first node Q3. The second transistor T32 may be connected between the first transistor T31 and the first node Q3. A gate of the second transistor T32 may be connected to the second voltage input terminal V2. The second transistor T32 may be turned on by the second voltage VGL input to the second voltage input terminal V2 and may transmit a start signal input through the first transistor T31 to the first node Q3. The second transistor T32 may always be in a turned-on state. Because the second transistor T32 shares stress caused by a multi-step voltage change of the first node Q3 with the first transistor T31, stress on the first transistor T31 may be relieved compared to a stage in which the second transistor T32 is omitted and the first transistor T31 is provided alone. Also, when the first transistor T31 is turned off, a line voltage drop between the input terminal IN and the first node Q3 may be prevented by the second transistor T32.

The third transistor T33 may be connected between the input terminal IN and the second node QB3. A gate of the third transistor T33 may be connected to the first clock terminal CK1. The third transistor T33 may be turned on when the first clock signal CLK1 input to the first clock terminal CK1 is at a high level and may transmit a start signal input to the input terminal IN to the second node QB3.

The fourth transistor T34 may be connected between the second node QB3 and the second voltage input terminal V2. A gate of the fourth transistor T34 may be connected to the first clock terminal CK1. The fourth transistor T34 may be turned on when the first clock signal CLK1 input to the first clock terminal CK1 is at a low level and may transmit the second voltage VGL input to the second voltage input terminal V2 to the second node QB3. Because the second voltage VGL, which is a constant voltage, rather than a clock signal, is used as a low-level voltage of the second node QB3 through the fourth transistor T34, a high-level gate signal output may be reliably ensured.

The output circuit 155 may be connected between the first voltage input terminal V1 and the second clock terminal CK2. The output circuit 155 may output the gate signal GS[k] of one of a high-level voltage and a low-level voltage according to voltage levels of the first node Q3 and the second node QB3. The output circuit 155 may include the fifth transistor T35 and the sixth transistor T36. The output circuit 155 may further include a capacitor C3.

The fifth transistor T35 may be connected between the output terminal OUT and the second clock terminal CK2. A gate of the fifth transistor T35 may be connected to the first node Q3. The fifth transistor T35 may be a pull-down transistor that transmits a low-level voltage to the output terminal OUT. The fifth transistor T35 may be turned on when the first node Q3 is at a low level and may transmit the second clock signal CLK2 input to the second clock terminal CK2 to the output terminal OUT.

The sixth transistor T36 may be connected between the first voltage input terminal V1 and the output terminal OUT. A gate of the sixth transistor T36 may be connected to the second node QB3. The sixth transistor T36 may be a pull-up transistor that transmits a high-level voltage to the output terminal OUT. The sixth transistor T36 may be turned on when the second node QB3 is at a low level and may output the first voltage VGH of a high-level voltage input to the first voltage input terminal V1 to the output terminal OUT.

A capacitor C3 may be connected between the output terminal OUT and the first node Q3. When the first transistor T31 is turned off, a voltage level of the first node Q3 may be maintained by the capacitor C3. When a voltage level at the output terminal OUT is changed from a high level to a low level, a low-level voltage of the first node Q3 may be changed to a lower low-level voltage by the capacitor C3.

Hereinafter, an operation of the stage STkc of FIG. 11 will be described with reference to FIG. 12. In FIG. 12, the previous gate signal GS[k−1] as a start signal, the first clock signal CLK1, the second clock signal CLK2, a voltage VQ3 of the first node Q3, a voltage VQB3 of the second node QB3, and the gate signal GS[k] as an output signal are illustrated.

In a first interval P31, the previous gate signal GS[k−1] of a low level may be supplied from a previous stage to the input terminal IN, the first clock signal CLK1 of a low level may be supplied to the first clock terminal CK1, and the second clock signal CLK2 of a high level may be supplied to the second clock terminal CK2.

The first transistor T31 and the fourth transistor T34 may be turned on by the first clock signal CLK1 of a low level, and the third transistor T33 may be turned off. The second transistor T32 may be in a turned-on state due to the second voltage VGL of a low level.

The previous gate signal GS[k−1] of a low level may be transmitted to the first node Q3 by the first transistor T31 and the second transistor T32 that are turned on, and a voltage VQ3 of the first node Q3 may be a low-level voltage. Accordingly, the fifth transistor T35 may be turned on, and the second clock signal CLK2 of a high level may be transmitted to the output terminal OUT.

The second voltage VGL of a low level may be transmitted to the second node QB3 by the fourth transistor T34 that is turned on, and a voltage VQB3 of the second node QB3 may be a low-level voltage. Accordingly, the sixth transistor T36 may be turned on, and the first voltage VGH of a high level may be transmitted to the output terminal OUT.

Accordingly, the gate signal GS[k] of a high level may be output from the output terminal OUT. A voltage difference between the output terminal OUT and the first node Q3 may be stored in the capacitor C3. In an embodiment, the first and second clock signals CLK1 and CLK2 may have a high level corresponding to the first voltage VGH of a high level and a low level corresponding to the second voltage VGL of a low level. The gate signal GS[k] has a high level corresponding to the first voltage VGH in the first interval P31. The voltage difference between the output terminal OUT and the first node Q3 may correspond to a value of |VGH-VGL|.

In a second interval P32, the previous gate signal GS[k−1] of a high level may be supplied to the input terminal IN, the first clock signal CLK1 of a high level may be supplied to the first clock terminal CK1, and the second clock signal CLK2 of a high level may be supplied to the second clock terminal CK2.

The first transistor T31 and the fourth transistor T34 may be turned off by the first clock signal CLK1 of a high level, and the third transistor T33 may be turned on. The second transistor T32 may be in a turned-on state due to the second voltage VGL of a low level.

The previous gate signal GS[k−1] of a high level may be transmitted to the second node QB3 by the third transistor T33 that is turned on, and a voltage VQB3 of the second node QB3 may be a high-level voltage. Accordingly, the sixth transistor T36 may be turned off.

Because the first node Q3 maintains a low-level voltage in the first interval P31 due to the capacitor C3, a turned-on state of the fifth transistor T35 may be maintained, and thus, the second clock signal CLK2 of a high level may be transmitted to the output terminal OUT. Accordingly, the gate signal GS[k] of a high level may be output from the output terminal OUT.

In a third interval P33, the previous gate signal GS[k−1] of a high level may be supplied to the input terminal IN, the first clock signal CLK1 of a high level may be supplied to the first clock terminal CK1, and the second clock signal CLK2 of a low level may be supplied to the second clock terminal CK2.

Because the first clock signal CLK1 maintains a high level, a turned-off state of the first transistor T31 and the fourth transistor T34 may be maintained, and a turned-on state of the third transistor T33 may be maintained. The second transistor T32 may be in a turned-on state due to the second voltage VGL of a low level.

The previous gate signal GS[k−1] of a high level may be transmitted to the second node QB3 by the third transistor T33 that is turned on, and a voltage VQB3 of the second node QB3 may be a high-level voltage. Accordingly, the sixth transistor T36 may be turned off.

The second clock signal CLK2 of a low level may be transmitted to the output terminal OUT through the fifth transistor T35 whose turned-on state is maintained. Accordingly, the gate signal GS[k] of a low level may be output from the output terminal OUT. As a voltage of the output terminal OUT falls from a high level to a low level, a voltage VQ3 of the first node Q3 may fall to a voltage level lower than a voltage level in the second interval P32 due to coupling of the capacitor C3. In an embodiment, the first and second clock signals CLK1 and CLK2 may have a high level corresponding to the first voltage VGH of a high level and a low level corresponding to the second voltage VGL of a low level. In the second interval P32, no charging or discharging by the input terminal IN due to the turned-off first transistor T31 occurs to the capacitor C3, and thus the capacitor C3 keeps the voltage difference of |VGH-VGL|. In the third interval P33, a voltage of the output terminal OUT that is an electrode of the capacitor C3 decreases from the first voltage VGH to the second voltage VGL, and thus a voltage of the other electrode of the capacitor C3 which corresponds to the first node Q3 decreases from the second voltage VGL to a lower voltage than the second voltage VGL.

In a fourth interval P34, the previous gate signal GS[k−1] of a high level may be supplied to the input terminal IN, the first clock signal CLK1 of a high level may be supplied to the first clock terminal CK1, and the second clock signal CLK2 of a high level may be supplied to the second clock terminal CK2.

Because the first clock signal CLK1 maintains a high level, a turned-off state of the first transistor T31 and the fourth transistor T34 may be maintained, and a turned-on state of the third transistor T33 may be maintained. The second transistor T32 may be in a turned-on state due to the second voltage VGL of a low level.

The previous gate signal GS[k−1] of a high level may be transmitted to the second node QB3 by the third transistor T33 that is turned on, and a voltage VQB3 of the second node QB3 may be a high-level voltage. Accordingly, the sixth transistor T36 may be turned off.

The second clock signal CLK2 of a high level may be transmitted to the output terminal OUT through the fifth transistor T35 whose turned-on state is maintained. Accordingly, the gate signal GS[k] of a high level may be output from the output terminal OUT. As a voltage of the output terminal OUT rises from a low level to a high level, a voltage VQ3 of the first node Q3 may rise to a low level (e.g., about a voltage level in the second interval P32) higher than a voltage level in the third interval P33 due to coupling of the capacitor C3. In an embodiment, the first and second clock signals CLK1 and CLK2 may have a high level corresponding to the first voltage VGH and a low level corresponding to the second voltage VGL. In the third interval P33, no charging or discharging by the input terminal IN due to the turned-off first transistor T31 occurs to the capacitor C3, and thus the capacitor C3 keeps the voltage difference corresponding to a value of |VGH-VGL|. In the fourth interval P34, a voltage of the output terminal OUT that is an electrode of the capacitor C3 increases from the second voltage VGL to the first voltage VGH, and thus a voltage of the other electrode of the capacitor C3 which corresponds to the first node Q3 increases from the lower voltage than the second voltage VGL to the second voltage VGL.

In a fifth interval P35, the previous gate signal GS[k−1] of a high level may be supplied to the input terminal IN, the first clock signal CLK1 of a low level may be supplied to the first clock terminal CK1, and the second clock signal CLK2 of a high level may be supplied to the second clock terminal CK2.

The first transistor T31 and the fourth transistor T34 may be turned on by the first clock signal CLK1 of a low level, and the third transistor T33 may be turned off. The second transistor T32 may be in a turned-on state due to the second voltage VGL of a low level.

The previous gate signal GS[k−1] of a high level may be transmitted to the first node Q3 by the first transistor T31 that is turned on and the second transistor T32, and a voltage VQ3 of the first node Q3 may be a high-level voltage. Accordingly, the fifth transistor T35 may be turned off.

The second voltage VGL of a low level may be transmitted to the second node QB3 by the fourth transistor T34 that is turned on, and a voltage VQB3 of the second node QB3 may be a low-level voltage. Accordingly, the sixth transistor T36 may be turned on, and the first voltage VGH of a high level may be transmitted to the output terminal OUT. Accordingly, the gate signal GS[k] of a high level may be output from the output terminal OUT. In an embodiment, the first and second clock signals CLK1 and CLK2 may have a high level corresponding to the first voltage VGH and a low level corresponding to the second voltage VGL. In the fifth interval P35, discharging by the input terminal IN due to the turned-on first transistor T31 occurs to the capacitor C3, and since a voltage of the output terminal OUT and a voltage VQ3 of the first node Q3 are the same, no charges are stored in the capacitor C3 in the fifth interval P35.

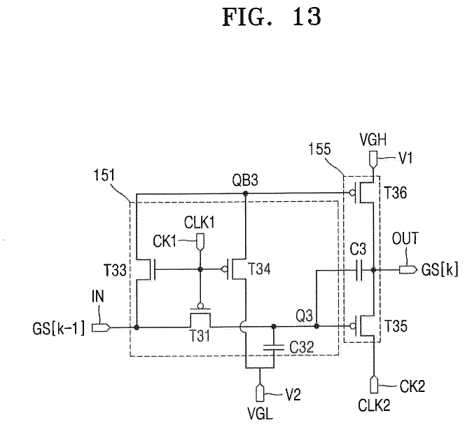

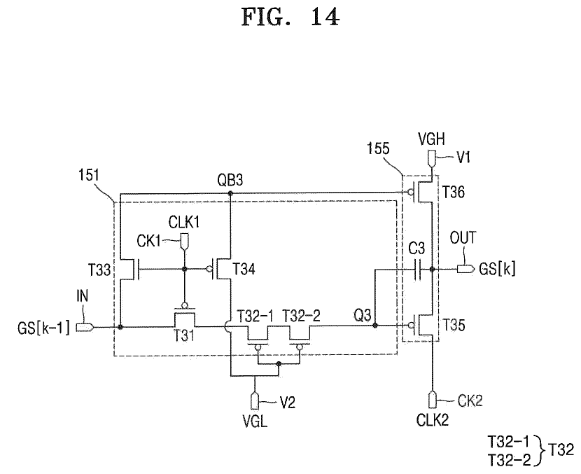

FIGS. 13 and 14 are circuit diagrams illustrating an example of a stage included in the gate driving circuit of FIG. 2. Hereinafter, a difference from the stage of FIG. 11 will be mainly described.

The stage of FIG. 13 is different from the stage STkc of FIG. 11 in that the second transistor T32 is omitted and a capacitor C32 is provided, and other elements and operations are the same as those of the stage STkc of FIG. 11. The capacitor C32 may be connected between the first node Q3 and the second voltage input terminal V2. Stress on the first transistor T31 due to a multi-step voltage change of the first node Q3 may be relieved by the capacitor C32.

The stage of FIG. 14 is different from the stage STkc of FIG. 11 in that the second transistor T32 has a structure in which a plurality of sub-transistors are connected in series, and other elements and operations are the same as those of the stage STkc of FIG. 11. The second transistor T32 may include a plurality of sub-transistors connected in series between the first transistor T31 and the first node Q3. The sub-transistors may include one pair of sub-transistors, i.e., a first sub-transistor T32-1 and a second sub-transistor T32-2. Gates of the first sub-transistor T32-1 and the second sub-transistor T32-2 may be connected to the second voltage input terminal V2. The first sub-transistor T32-1 and the second sub-transistor T32-2 may always be in a turned-on state due to the second voltage VGL input to the second voltage input terminal V2.

According to embodiments, voltage levels of a node to which a gate of a pull-up transistor is connected and a node to which a gate of a pull-down transistor is connected may be independently controlled, without controlling a voltage level of the node to which the gate of the pull-down transistor is connected to be inverted according to a voltage level of the node to which the gate of the pull-up transistor is connected or controlling a voltage level of the node to which the gate of the pull-up transistor is connected to be inverted according to a voltage level of the node to which the gate of the pull-down transistor is connected.

According to embodiments, there may be provided a driving circuit that may be configured with a small number of transistors and capacitors to minimize a dead space and may stably output a gate signal, and a display apparatus including the driving circuit.

According to an embodiment, there may be provided a gate driving circuit that may be configured with a small number of circuit devices to reduce the area of a non-display area and stably output a gate signal, and a display apparatus including the gate driving circuit. The effects of the disclosure are not limited to the above effects, and may vary without departing from the scope of the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by one of ordinary skill in the art that various changes in form and details may be made therein without departing from the spirit and scope as defined by the following claims.

What is claimed is:

1. A driving circuit comprising a plurality of stages that output a plurality of gate signals to a plurality of pixels,
wherein each of the plurality of stages comprises:
a first transistor connected between a first terminal and a first node and configured to control a voltage level of the first node, wherein the first terminal receives a first signal;
a second transistor connected between a second terminal and a second node and configured to control a voltage level of the second node, wherein the second terminal receives a second signal;
a third transistor connected between a third terminal and the second node and configured to control the voltage level of the second node, wherein the third terminal receives a third signal; and
an output circuit configured to output a corresponding gate signal, among the plurality of gate signals, of one of a high-level voltage and a low-level voltage according to the voltage level of the first node and the voltage level of the second node.

2. The driving circuit of claim 1,
wherein the plurality of stages include a first stage, a last stage, and a plurality of intervening stages which are connected with each other in series,
wherein the plurality of intervening stages are connected with each other in series and disposed between the first stage and the last stage, and
wherein the first stage receives an external signal as the first signal, and
wherein each of the last stage and the plurality of intervening stages receives a corresponding gate signal, among the plurality of gate signals, output from a previous stage of the plurality of stages.

3. The driving circuit of claim 1,
wherein a gate of each of the first transistor, the second transistor, and the third transistor is connected to a first clock terminal receiving a first clock signal,
wherein the first transistor and the second transistor are P-type transistors, and
wherein the third transistor is an N-type transistor.

4. The driving circuit of claim 3, wherein:
the second signal is a first voltage of a low level, and
the third signal is a second voltage of a high level.

5. The driving circuit of claim 1,
wherein a gate of each of the first transistor, the second transistor, and the third transistor is connected to a first clock terminal receiving a first clock signal,
wherein the first transistor and the third transistor are P-type transistors, and
wherein the second transistor is an N-type transistor.

6. The driving circuit of claim 5, wherein:
the second signal is a same signal as the first signal, and
the third signal is a first voltage of a low level.

7. The driving circuit of claim 1, wherein:
a gate of each of the first transistor and the second transistor is connected to a first clock terminal to which a first clock signal is input,
a gate of the third transistor is connected to a second clock terminal to which a second clock signal is input,
the first transistor is a P-type transistor, and
the second transistor and the third transistor are N-type transistors.

8. The driving circuit of claim 7, wherein:
the second signal is a same signal as the first signal, and
the third signal is the first clock signal.

9. The driving circuit of claim 1,
wherein each of the plurality of stages further comprises:
a fourth transistor connected between the first transistor and the first node and comprising a gate connected to a terminal to which a first voltage of a low level is input.

10. The driving circuit of claim 9,
wherein the fourth transistor comprises two sub-transistors that are connected in series.

11. The driving circuit of claim 1,
wherein each of the plurality of stages further comprises:
a capacitor connected between the first node and a terminal to which a first voltage of a low level is supplied.

12. The driving circuit of claim 1,
wherein the output circuit comprises:
a pull-down transistor connected between an output terminal and a clock terminal and comprising a gate connected to the first node;
a pull-up transistor connected between a terminal to which a second voltage of a high level is supplied and the output terminal and comprising a gate connected to the second node; and
a capacitor connected between the first node and the output terminal.

13. A driving circuit comprising a plurality of stages that output a plurality of gate signals to a plurality of pixels,
wherein each of the plurality of stages comprises:
a first transistor connected between a first node and an input terminal to which a start signal is input and comprising a gate connected to a first clock terminal to which a first clock signal is input;
a second transistor connected between a second node and a first voltage input terminal to which a first voltage of a low level is input and comprising a gate connected to the first clock terminal;
a third transistor connected between the second node and a second voltage input terminal to which a second voltage of a high level is input and comprising a gate connected to the first clock terminal; and
an output circuit connected to the second voltage input terminal and a second clock terminal to which a second clock signal is input and configured to output a corresponding gate signal, among the plurality of gate signals, of one of a high-level voltage and a low-level voltage according to a voltage level of the first node and a voltage level of the second node, and
wherein the first transistor and the second transistor are P-type transistors, and the third transistor is an N-type transistor.

14. The driving circuit of claim 13,
wherein each of the plurality of stages further comprises:
a fourth transistor connected between the first transistor and the first node and comprising a gate connected to the first voltage input terminal.

15. The driving circuit of claim 14,
wherein the fourth transistor comprises two sub-transistors that are connected in series.

16. The driving circuit of claim 13,
wherein each of the plurality of stages further comprises a capacitor connected between the first node and the first voltage input terminal.

17. A driving circuit comprising a plurality of stages that output a plurality of gate signals to a plurality of pixels,
wherein each of the plurality of stages comprises:
a first transistor connected between a first node and an input terminal to which a start signal is input and comprising a gate connected to a first clock terminal to which a first clock signal is input;
a second transistor connected between the input terminal and a second node and comprising a gate connected to the first clock terminal;
a third transistor connected between the first clock terminal and the second node and comprising a gate connected to a second clock terminal to which a second clock signal is input; and
an output circuit connected between the second clock terminal and a first voltage input terminal to which a first voltage of a high level is input and configured to output a corresponding gate signal, among the plurality of gate signals, of one of a high-level voltage and a low-level voltage according to a voltage level of the first node and a voltage level of the second node, and
wherein the first transistor is a P-type transistor, and the second transistor and the third transistor are N-type transistors.

18. The driving circuit of claim 17,
wherein each of the plurality of stages further comprises:
a fourth transistor connected between the first transistor and the first node and comprising a gate connected to a second voltage input terminal to which a second voltage of a low level is input.

19. The driving circuit of claim 18,
wherein the fourth transistor comprises two sub-transistors that are connected in series.

20. The driving circuit of claim 17,
wherein each of the plurality of stages further comprises:
a capacitor connected between the first node and a second voltage input terminal to which a second voltage of a low level is input.

21. A driving circuit comprising a plurality of stages that output a plurality of gate signals to a plurality of pixels,
wherein each of the plurality of stages comprises:
a first transistor connected between a first node and an input terminal to which a start signal is input and comprising a gate connected to a first clock terminal to which a first clock signal is input;
a second transistor connected between the input terminal and a second node and comprising a gate connected to the first clock terminal;
a third transistor connected between the second node and a first voltage input terminal to which a first voltage of a low level is input and comprising a gate connected to the first clock terminal; and
an output circuit connected between a second voltage input terminal to which a second voltage of a high level is input and a second clock terminal to which a second clock signal is input and configured to output a corresponding gate signal, among the plurality of gate signals, of one of a high-level voltage and a low-level voltage according to a voltage level of the first node and a voltage level of the second node, and
wherein the first transistor and the third transistor are P-type transistors, and the second transistor is an N-type transistor.

22. The driving circuit of claim 21,
wherein each of the plurality of stages further comprises:
a fourth transistor connected between the first transistor and the first node and comprising a gate connected to the first voltage input terminal.

23. The driving circuit of claim 22,
wherein the fourth transistor comprises two sub-transistors that are connected in series.

24. The driving circuit of claim 21,
wherein each of the plurality of stages further comprises:
a capacitor connected between the first node and the first voltage input terminal.
